(19) United States
(12) Patent Application Publication
(10) Pub. No.: US 2019/0126389 A1
(43) Pub. Date: May 2, 2019

(54) LASER-WELDING APPARATUS AND LASER-WELDING METHOD

(71) Applicant: PANASONIC INTELLECTUAL PROPERTY MANAGEMENT CO., LTD., Osaka (JP)

(72) Inventors: Takayuki FUKAE, Osaka (JP); Takashi URASHIMA, Osaka (JP); Toshiyuki MISHIMA, Osaka (JP); Toru SAKAI, Hyogo (JP); Michio SAKURAI, Osaka (JP)

(73) Assignee: PANASONIC INTELLECTUAL PROPERTY MANAGEMENT CO., LTD., Osaka (JP)

(21) Appl. No.: 16/170,831

(22) Filed: Oct. 25, 2018

(30) Foreign Application Priority Data
Oct. 26, 2017 (JP) 2017-207497

(51) Int. Cl. B23K 26/03; B23K 26/06; B23K 26/22; B23K 31/12

(52) U.S. Cl. CPC B23K 26/032; B23K 26/0604; B23K 26/0643; G01B 11/22; B23K 26/22; B23K 31/125; B23K 26/0652

(57) ABSTRACT

The present invention relates to a laser-welding apparatus and a laser-welding method. The laser-welding apparatus of the present invention includes: a laser output section that emits a laser beam toward a weld part of a welding target member; an optical interferometer that measures a weld penetration depth of the weld part based on interference which occurs due to an optical path difference between a measurement beam and a reference beam, the measurement beam having a frequency length different from that of the laser beam and having been emitted to the weld part while being coaxially overlapped with the laser beam, and reflected by the weld part; and a protection optical member disposed on an optical path between the welding target member and the laser output section while being inclined with respect to a plane perpendicular to an optical axis of the measurement beam.

### CROSS REFERENCE TO RELATED APPLICATIONS

This application is entitled to and claims the benefit of Japanese Patent Application No. 2017-207497, filed on Oct. 26, 2017, the disclosure of which including the specification, drawings and abstract is incorporated herein by reference in its entirety.

### TECHNICAL FIELD

The present invention relates to a laser-welding apparatus and a laser-welding method for evaluating quality of a weld part in welding using a laser beam.

### BACKGROUND ART

As a traditional welding apparatus, there is a laser-welding apparatus which accurately performs evaluation of a weld part by directly measuring a depth of the weld part (Patent Literature (hereinafter, referred to as “PTL”) 1).

More specifically; as illustrated in FIG. 6, in laser-welding apparatus 100, a measurement beam from optical interferometer 105 is emitted to weld part 102 of welding-target member 101 via first beam splitter 106 such that the measurement beam is concentrically and coaxially overlapped, with a laser beam from laser oscillator 107. Molten puddle 103 and keyhole 104 are formed in weld part 102 by the laser beam. The measurement beam is reflected by bottom part 104a of keyhole 104 and returns to optical interferometer 105 via first beam splitter 106. Optical interferometer 105 can measure an optical path length of the measurement beam, so that optical interferometer 105 can identify a depth of keyhole 104 from the measured optical path length as a weld penetration depth. Laser-welding apparatus 100 determines quality of weld part 102 based on the weld penetration depth identified in the manner described above.

As illustrated in FIG. 6, laser-welding apparatus 100 includes: laser beam transmission optical system. 108; first light collection optical system 109; first moving stage 110; stage controller 111; computer 112; control section (controller) 112a; measurement section 112b; evaluation section 112c; second light collection optical system 120; interference filter 121; and display section 122.

As illustrated in FIG. 6, optical interferometer 105 of laser-welding apparatus 100 includes: optical fiber system 114; first optical fiber system 114a; second optical fiber system 114b; first fiber coupler 115; reference mirror 116; second fiber coupler 117; differential detector 118; first input 118a; second input 118b; and A/D converter 119.

### CITATION LIST

### Patent Literature

### PTL 1

Japanese Patent No. 5252026

### SUMMARY OF INVENTION

### Technical Problem

Meanwhile, granular solids resulting from dispersion of melted metal and/or fine particles so called spatters or fumes are generated during laser welding. In order to protect an apparatus from spatters and/or fumes, a protection optical member, such as protection glass, is installed in general laser-welding apparatus 100. In this case, the measurement beam from optical interferometer 105 is emitted to weld part 102 while passing through the above-mentioned protection optical member.

That is, not only a reflection beam from keyhole 104 but also a reflection beam from a surface of the protection optical member enters into optical interferometer 105. For this reason, there occurs a problem in that a pseudo-noise is measured due to a coherence revival phenomenon. Hereafter, the pseudo-noise measured due to the coherence revival phenomenon is referred to as a “coherence revival noise.”

The coherence revival noise will be described, herein.

In the above related art, although wavelength scanning beam source 113 is used as a measurement beam, an external resonator-type beam source is mainly used for this. In the external resonator-type beam source, when the length of the external resonator is set to L, a singularity where beams of all wavelengths become nodes exists for each length L. For this reason, when there is a noise due to a surface reflection of a protection optical member, for example, this noise is measured not only in the actual reflection surface but also in a position distant from the reflection surface by n×L. Such noise is a coherence revival noise.

Depending on the distance to keyhole 104, there may be a situation where coherence revival noises due to surface reflection of protection glass may overlap with each other, and it becomes difficult to correctly measure the distance to keyhole 104.

An object of the present invention is thus to provide a laser-welding apparatus which modifies coherence revival noises and which can accurately measure a depth of a weld part.

### Solution to Problem

To achieve the above object, the present invention provides a laser-welding apparatus including: a laser output section that emits a laser beam toward a weld part of a welding target member; an optical interferometer that measures a weld penetration depth of the weld part based on interference which occurs due to an optical path difference between a measurement beam and a reference beam, the measurement beam having been emitted to the weld part while being coaxially overlapped with the laser beam and then reflected by the weld part; and at least one protection optical member disposed on an optical path between the welding target member and the laser output section while being inclined with respect to a plane perpendicular to an optical axis of the measurement beam.

### Advantageous Effects of Invention

According to laser welding of the present invention, a returned beam to an optical interferometer due to reflection on a surface of a protection optical member is removed by attaching the protection optical member, such as protection glass, in an inclined manner, and occurrence of a measurement noise generated due to a reflection beam on the surface of the protection optical member can be prevented. Thus, a laser-welding apparatus capable of accurately measuring a depth of a weld part can be achieved.

### BRIEF DESCRIPTION OF DRAWINGS

FIG. 1 is a diagram illustrating a configuration of a laser-welding apparatus in Embodiment 1;

FIG. 2 is a diagram for describing influence of surface reflection on a protection optical member;

FIG. 3 is a diagram for describing effects of the laser-welding apparatus in Embodiment 1;

FIG. 4 is a diagram illustrating a configuration of a laser-welding apparatus in Embodiment 2;

FIG. 5 is a diagram for describing effects of the laser-welding apparatus in Embodiment 2; and

FIG. 6 is a diagram illustrating a traditional laser-welding apparatus.

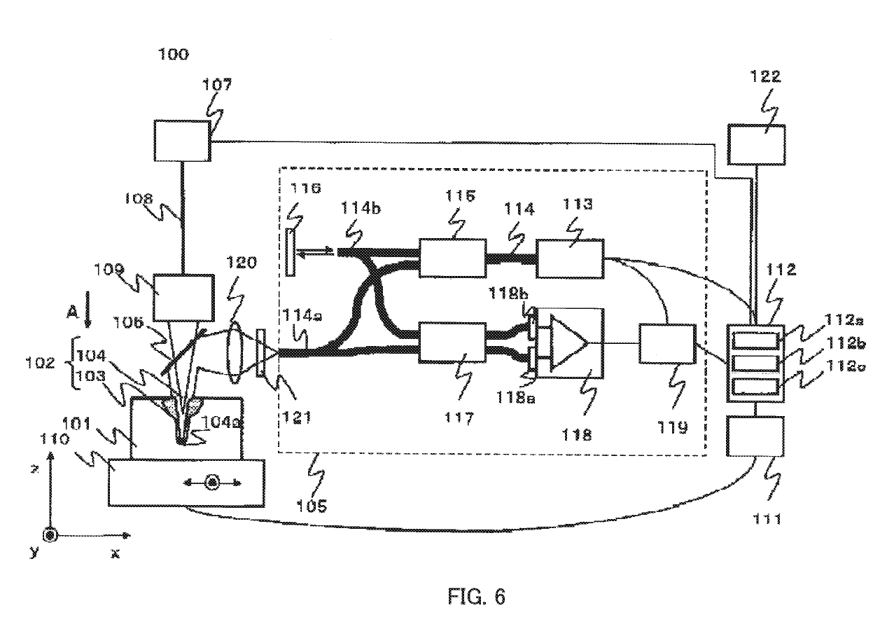

### DESCRIPTION OF EMBODIMENTS

Hereinafter, embodiments of the present invention will be described with reference to the accompanying drawings.

### Embodiment 1

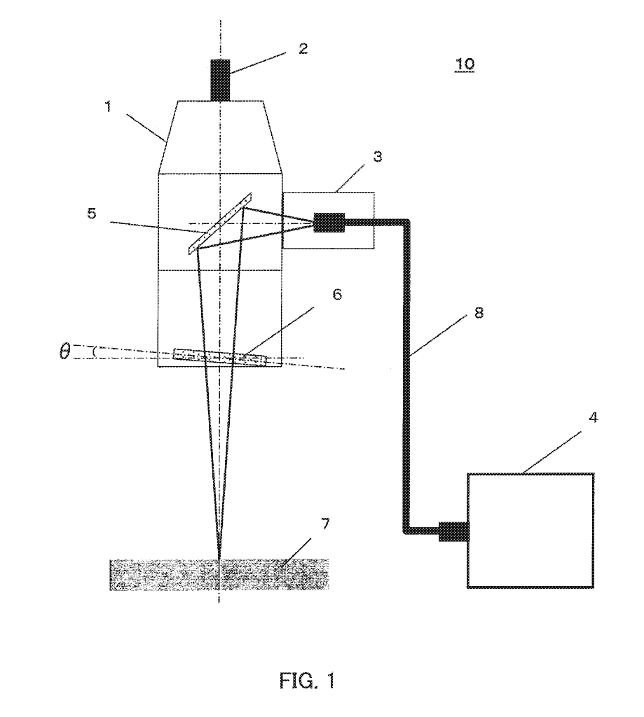

Embodiment 1 of the present invention will be described with reference to FIG. 1 to FIG. 3, hereinafter.

FIG. 1 is a diagram illustrating a configuration example of laser-welding apparatus 10 according to Embodiment 1. Laser welding head 1 includes: laser oscillator 2 which outputs a laser beam for laser welding welding target member 7; and measurement beam entering part 3 through which a measurement beam for measuring a welding depth at the time of welding. Measurement beam entering part 3 is connected to optical interferometer 4 through optical fiber system 8. Note that, laser oscillator 2 is an example of laser output means of the present invention.

The measurement beam emitted from optical interferometer 4 is outputted from measurement beam entering part 3 through optical fiber system 8 and is directed to welding target material 7 while being concentrically and coaxially overlapped with a laser beam from laser oscillator 2 by beam splitter 5. The directed measurement beam is reflected by target welding material 7, is returned to measurement beam entering part 3 via beam splitter 5, and enters optical interferometer 4 through optical fiber system 8.

Optical interferometer 4 measures a weld penetration depth of welding target material 7, using the technique of Swept Source Optical Coherence Tomography (SS-OCT: wavelength scanning type beam interference tomography). Optical interferometer 4 measures an optical path length of the measurement beam and thus can measure penetration depth of welding target material 7 based on the measured optical path length.

In order to protect an optical member, such as a lens disposed in a head, from spatters and/or fumes generated during processing of welding target material 7, protection optical member 6, such as a protection lens, is attached in laser welding head 1. Protection optical member 6, such as a protection lens, is attached while being inclined by only an inclination angle θ with respect to a plane perpendicular to an optical axis of a measurement beam of protection optical member 6.

As described above, the measurement beam outputted from optical interferometer 4 is emitted from measurement beam entering part 3 through optical fiber system S and directed to welding target material 7 while being concentrically and coaxially overlapped with a laser beam from laser oscillator 2 by beam splitter 5 and passing through protection optical member 6. However, a part of the measurement beam does not fully pass through protection optical member 6 and is reflected on a surface of protection optical member 6. In Embodiment 1, a wavelength scanning type beam source is used as a beam source of the measurement beam of optical interferometer 4. This wavelength scanning type beam source is an external resonator-type beam source, as described above. Note that, the term “wavelength scanning” means to periodically change the center wavelength of the measurement beam emitted from a beam source.

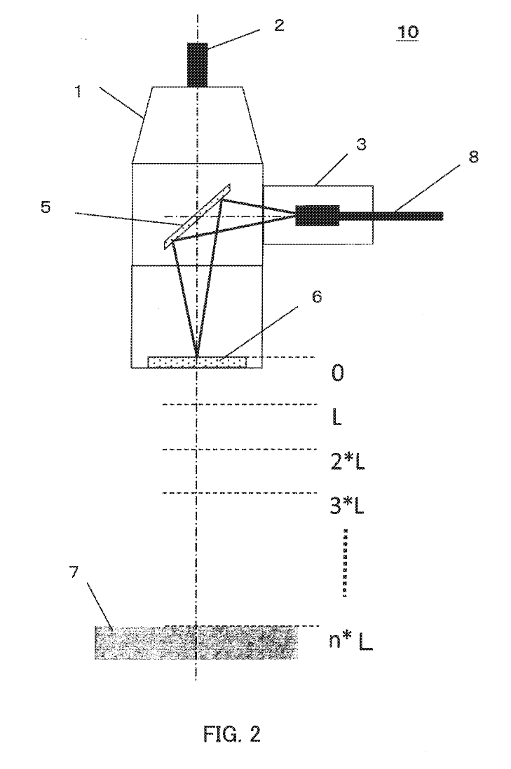

In an external resonator-type beam source, when the length of the external resonator is set to L, a singularity where beams of all wavelengths become nodes exists for each length L. For this reason, as illustrated in FIG. 2, when a noise due to surface reflection of protection optical member 6 exists, for example, a coherence revival noise is measured not only in an actual reflection surface but also in a position distant from the reflection surface by n×L.

FIG. 2 illustrates an example in which the distance from the surface of protection optical member 6 to welding target material 7 is n×L. In this case, a coherent revival noise due to surface reflection of protection optical member 6 is overlapped with a measurement beam indicating a welding depth desired to be measured actually, and there arises a problem in that the welding depth cannot be accurately measured. Therefore, it is necessary to suppress the surface reflection on protection optical member 6.

As a general method for antireflection, a method of providing an antireflection film is mentioned, for example. However, providing protection optical member 6 with the antireflection film causes an increase in unit cost of protection optical member 6. Since protection optical member 6 is a consumable member that requires regular replacement, an increase in unit cost is not favorable for users of laser-welding apparatus 10. Further, since it is impossible to completely prevent surface reflection of protection optical member 6 even when an antireflection film is provided, depending on the required accuracy of measurement, it may become a problem.

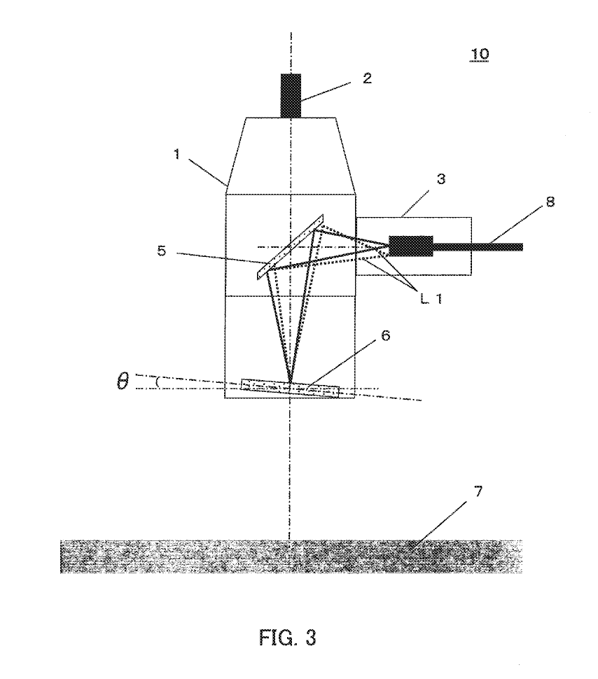

With laser-welding apparatus 10 according to Embodiment 1, a coherent revival noise due to surface reflection of protection optical member 6 can be removed without providing an antireflection film. FIG. 3 is a diagram for describing the effects of laser-welding apparatus 10 according to Embodiment 1.

As illustrated in FIG. 1 and FIG. 3, in laser-welding apparatus 10 according to Embodiment 1, protection optical member 6 is attached while being inclined only by angle θ with respect to a plane perpendicular to the optical axis of a measurement beam. With this configuration, as illustrated in FIG. 3, shifting occurs on reflection beam L1 due to surface reflection of protection optical member 6, and reflection beam L1 no longer enters optical fiber system 8. When reflection beam L1 no longer enters optical fiber system 8, no reflection beam L1 is detected in optical interferometer 4 (illustration is omitted in FIG. 3), and the problem with noise due to a reflection beam does not occur either. For this reason, laser-welding apparatus 10 according to Embodiment 1 can acquire the same effect as suppressing surface reflection of protection optical member 6.

Inclination angle θ of protection optical member 6 is suitably determined depending on the optical path length between protection optical member 6 and optical fiber system 8. More specifically, with a size (e.g., about 200 to 300 mm) of a general laser welding head 1, setting inclination angle θ to be at least 0.5 degree, for example, starts producing an effect. In considering that protection optical member 6 is a consumable member involving a frequent replacement operation, an inclination angle of about 1 degree is suitable because of likelihood of attachment accuracy, and an increase in installation space of a protection optical member when a large inclination angle is set.

As described above, in laser-welding apparatus 10 according to Embodiment 1, attachment of protection optical member 6 while protection optical member 6 is inclined with respect to a plane perpendicular to the optical axis of a measurement beam removes a coherence revival noise due to surface reflection of protection optical member 6 and makes it possible to accurately measure a welding depth.

### Embodiment 2

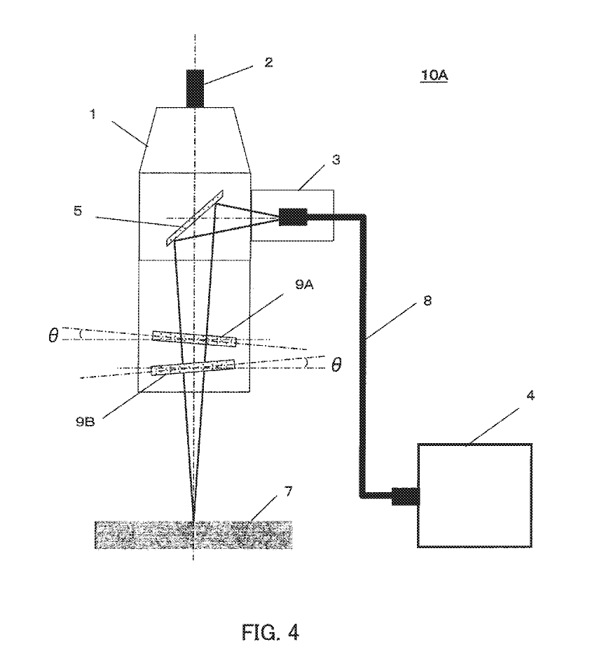

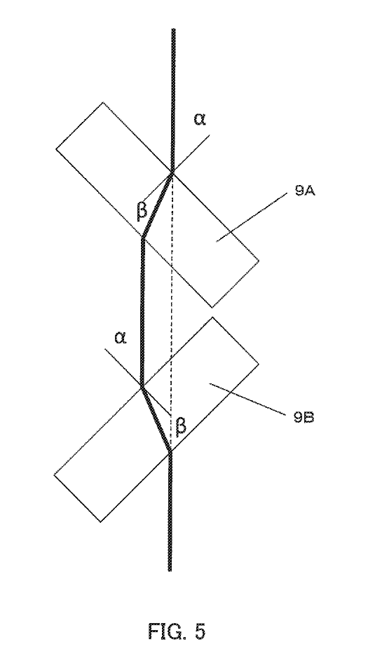

Hereinafter, Embodiment 2 of the present invention will be described with reference to FIG. 4 and FIG. 5.

In FIG. 4 and an FIG. 5, components similar to those of Embodiment 1 are assigned the same numerals and their descriptions are omitted. Although the configuration for achieving Embodiment 2 is similar to that of Embodiment 1, Embodiment 2 is different from Embodiment 1 in that a plurality of sheets of protection optical members is provided.

FIG. 4 is a diagram illustrating a configuration example of laser-welding apparatus 10A according to Embodiment 2. In order to protect an optical member, such as a lens disposed in a head, from spatters and/or fumes generated during processing of welding target material 7, protection optical members 9A and 9B, such as a plurality of sheets of protection lenses, are attached while being inclined by only inclination angle θ with respect to a plane perpendicular to an optical axis of a measurement beam in laser welding head 1A. Further, protection optical member 9A and protection optical member 9B are attached symmetrically while being mutually rotated by 180 degrees with respect to an optical axis of a measurement beam. Note that, FIG. 4 illustrates an example in which protection optical members 9A and 9B of two sheets are included, three or more sheets may be included.

FIG. 5 is a diagram for describing the effects of laser-welding apparatus 10A according to Embodiment 2. Note that, for the purpose of facilitating the description, the inclination angles of protection optical members are illustrated in an exaggerated manner in FIG. 5 compared with the actual angles.

As illustrated in FIG. 4, the measurement beam outputted from optical interferometer 4 is emitted from measurement beam entering part 3 through optical fiber system 8 and is directed to welding target material 7 while being concentrically and coaxially overlapped with the laser beam from laser oscillator 2 by beam splitter 5 and passing through protection optical member 9A and protection optical member 9B.

Protection optical member 9A and protection optical member 9B are attached while being inclined only by angle θ with respect to a plane perpendicular to the optical axis of a measurement beam. With this inclination, as in the case of protection optical member 6 of Embodiment 1, the influence of a coherence revival noise due to surface reflection of protection optical member 9A and protection optical member 9B can be removed.

Meanwhile, as illustrated in FIG. 5, as a result of attaching protection optical member 9A and protection optical member 9B in an inclined manner, there occurs, by Snell's law, shifting on an optical path with refraction angle with respect to incidence angle α. When a protective optical member of one sheet is employed as in Embodiment 1, the size of shifting is small and does not cause a significant problem when an incident position of a measurement beam from optical fiber system 8 is adjusted by measurement beam entering part 3, for example. However, when two or more protection optical members are present as in Embodiment 2, there arises a problem in that the shifting on the optical paths due to refraction is accumulated, and a laser welding position and an irradiation position of a measurement beam are shifted.

In order to solve this problem, in laser-welding apparatus 10A according to Embodiment 2, protection optical member 9A and protection optical member 9B are attached symmetrically while being mutually rotated by 180 degrees with respect to the optical axis of a measurement beam as illustrated in FIG. 4 and FIG. 5. With this configuration, as illustrated in FIG. 5, the optical path shifted by refraction on protection optical member 9A is returned to the original optical path conversely by refraction on protection optical member 9B. Attaching the protection optical members of two sheets symmetrically by mutually rotating 180 degrees with respect to the optical axis of a measurement beam cancels out the optical path shifted by refraction and also makes it possible to remove a coherence revival noise due to surface reflection of protection optical members 9A and 9B.

In a case where protection optical members of three or more sheets are used, repetition of attaching adjacent protection optical members symmetrically by mutually rotating 180 degrees with respect to the optical axis of a measurement beam makes it possible to obtain the same effects as the above. In terms of returning the optical path shifted by a protection optical member to the original by another protection optical member, protection optical members of a plurality of sheets are preferably configured to be grouped into pairs of protection optical members disposed in a rotationally symmetrical manner. Note that, there may be a case where it is difficult to attach all of the plurality of protection optical members in an inclined manner because of a limited size of laser welding head 1. In this case, a configuration may be employed in which some of the protection optical members are provided with antireflection films to suppress surface reflection of the protection optical members and attached in an ordinary way without inclination, and only inclinable protection optical members are attached in an inclined manner.

As described above, in laser-welding apparatus 10A according to Embodiment 2, protection optical members 9A and 9B of two sheets are inclined by the same angle with respect to a plane perpendicular to the optical axis of a measurement beam and are attached symmetrically while being mutually rotated by 180 degrees with respect to the optical axis of a measurement beam. With this configuration, shifting of an optical path due to attachment of protection optical members 9A and 9B in an inclined manner is canceled out, and a coherence revival noise due to surface reflection of protection optical members 9A and 9B can be removed.

### INDUSTRIAL APPLICABILITY

The present invention can be applied to laser welding for automobiles and/or electronic components or the like.

### REFERENCE SIGNS LIST

10, 10A Laser-welding apparatus
1 Laser welding head
2 Laser oscillator
3 Measurement beam incident part
4 Optical interferometer
5 Beam splitter
6, 9A, 9B Protection optical member
7 Welding target member
8 Optical fiber system
100 Laser-welding apparatus
101 Welding target member
102 Weld part
104 Keyhole
105 Optical interferometer
106 First beam splitter
107 Laser oscillator

1. A laser-welding apparatus, comprising:
a laser output section that emits a laser beam toward a weld part of a welding target member;
an optical interferometer that measures a weld penetration depth of the weld part based on interference which occurs due to an optical path difference between a measurement beam and a reference beam, the measurement beam having been emitted to the weld part while being coaxially overlapped with the laser beam and then reflected by the weld part; and
at least one protection optical member disposed on an optical path between the welding target member and the laser output section while being inclined with respect to a plane perpendicular to an optical axis of the measurement beam.

2. The laser-welding apparatus according to claim 1, wherein
the at least one protection optical member is inclined at an angle equal to or greater than 0.5 degree with respect to the plane perpendicular to the optical axis of the measurement beam.

3. The laser-welding apparatus according to claim 1, wherein
the at least one protection optical member includes protection optical members of two or more sheets, wherein
the protection optical members of two or more sheets are each disposed while being inclined with respect to the plane perpendicular to the optical axis of the measurement beam, and an n-th one of the protection optical members of two or more sheets and an (n+1)-th one of the protection optical members of two or more sheets are disposed symmetrically while being mutually rotated by 180 degrees.

4. The laser-welding apparatus according to claim 1, wherein
the at least one protection optical member includes protection optical members of two or more sheets, wherein
the protection optical members of two or more sheets are each disposed while being inclined with respect to the plane perpendicular to the optical axis of the measurement beam, and the protection optical members of two or more sheets are grouped into pairs each including a pair of the protection optical members of two or more sheets which are disposed in a rotationally symmetrical manner with respect to the optical axis.

5. A laser-welding method, comprising:
emitting a laser beam and a measurement beam having a wavelength different from that of the laser beam to a weld part of a welding target member while the laser beam and the measurement beam are coaxially overlapped with each other; and
measuring a weld penetration depth of the weld part based on interference which occurs due to an optical path difference between the measurement beam reflected by the weld part, and a reference beam, wherein
when the laser beam is emitted toward the welding target member via a protection optical member, the protection optical member is in a state of being inclined with respect to a plane perpendicular to an optical axis of the measurement beam.
